(19) United States
(12) Patent Application Publication
(10) Pub. No.: US 2025/0130905 A1
(43) Pub. Date: Apr. 24, 2025

(54) SOFTWARE BASED VALIDATION OF MEMORY FOR FAULT TOLERANT SYSTEMS

(71) Applicant: STRATUS TECHNOLOGIES IRELAND LTD., Dublin (IE)

(72) Inventor: John MacLeod, Cambridge, MA (US)

(73) Assignee: STRATUS TECHNOLOGIES IRELAND LTD., Dublin (IE)

(21) Appl. No.: 18/399,497

(22) Filed: Dec. 28, 2023

Related U.S. Application Data
(60) Provisional application No. 63/545,153, filed on Oct. 20, 2023.

(51) Int. Cl. G06F 11/20; G06F 11/07; G06F 11/10

(52) U.S. Cl. CPC G06F 11/2023; G06F 11/0772; G06F 11/1004

(57) ABSTRACT

In part, the disclosure relates to a computer system. The system includes a network device, a storage device and at least two compute nodes, wherein one compute node is designated an active node and the other compute node is designated a standby node. Each compute node may include a dedicated memory with an isolated utility executive, an operating system memory, and a firmware reserved memory and the active node operating system memory further includes an availability driver, wherein the availability driver of the active node disables or suspends all processes that alter operating system memory and transfers all operation system memory of the active node to the operating system memory of the standby node, the isolated utility executive of the active node executes a code to generate an active validation array set of all operating system memory, the active validation array is then transferred to the standby node.

### CROSS REFERENCE TO RELATED APPLICATIONS

This application is a U.S. patent application which claims priority to and the benefit of U.S. Provisional Patent Application No. 63/545,153, filed on Oct. 20, 2023.

### FIELD

The disclosure relates generally to a high reliability fault tolerant computer system and more specifically to a software based validation method for the equivalent memory state of a fault tolerant computer system.

### BACKGROUND

High reliability fault tolerant computer systems are computer systems which have at least “five nines” reliability. This means that the computer is functioning at least 99.999% of the time and has an unplanned down time of at most about only five minutes per year of continuous operation.

To accomplish this high reliability, such fault tolerant computer systems frequently have redundant components such that when one component fails, begins to fail, or is predicted to fail, the programs using the failing computer component instead use a similar but redundant component of the system.

Fault tolerant computer systems may also require failover capabilities that transfer the entire processor/OS memory states from one device to another device. The transfer of the memory state between nodes is allows one device to takeover for failing device when a problem is detected. If operating states are transferred, but the information incorrectly copied, missing, or there are corrupted memory pages, the fault tolerant operation is likely to fail.

The present disclosure addresses these challenges and others.

### SUMMARY

In part, in one aspect, the disclosure relates to a fault tolerant computer system. The computer system includes a network device, a storage device and at least two compute nodes, wherein one compute node is designated an active node and the other compute node is designated a standby node. In some embodiments, each compute node includes a dedicated memory with an isolated utility executive, an operating system memory, and a firmware reserved memory and the active node operating system memory further includes an availability driver, wherein the availability driver of the active node disables or suspends all processes that alter operating system memory and transfers all operation system memory of the active node to the operating system memory of the standby node, the isolated utility executive of the active node executes a code to generate an active validation array set of all operating system memory, the active validation array is then transferred to the standby node.

In some embodiments, the isolated utility executive of the standby node executes a code to generate a standby validation array set of all operating system memory that is verified against the active validation array. In one embodiment, the isolated utility executive of the standby node signals to the availability driver to complete or abort transfer of a network and storage device being used by the active node to the standby node.

In one embodiment, the compute nodes further comprise stack memory in the dedicated memory, wherein the stack memory can be verified through a data token. In one embodiment, the active validation array and standby validation array are generated by a checksum or hash function. In one embodiment, the isolated utility executive is a virtual machine monitor which executes in the dedicated memory to perform the validation array generation procured on the Standby node. In one embodiment, the isolated utility executive of the active node and of the standby node executes code on all processers of the computer system in parallel to generate the active validation array and the standby validation array.

In yet another aspect, the disclosure relates to a method for verifying memory transfer in a fault tolerant computer system. The system includes providing a first compute node and a second compute node, the compute nodes having memory, suspending system execution on the first compute node to prevent changes in memory on the first compute node, generating a first array for every page of memory on the first compute node wherein the full memory bandwidth operates in parallel, generating a second array for every page of memory on the second compute node wherein the full memory bandwidth operates in parallel, verifying consistency between the first arrays on the first compute node and the second arrays on the second compute node, transferring disk and network access to the second compute node; and resuming system execution on the second compute node.

In one embodiment, the arrays on the first compute node and the arrays on the second compute node are generated by a checksum or hash function. In one embodiment, the method further includes detecting an immediate or impending failure of the first compute node. In one embodiment, the memory further includes stack memory, and wherein each stack memory page is validated using a data token. In one embodiment, the method further comprises transferring the memory of the first compute node to a second compute node via a virtual machine monitor.

In still yet another aspect the disclosure relates to a computer system configured to migrate a PC Server. The computer system includes a network device, a storage device, at least two compute nodes, wherein one compute node is designated an active node and the other compute node is designated a standby node. In some embodiments, each compute node includes a dedicated memory with an isolated utility executive, an operating system memory, the operating system memory including a plurality of files or data structures that are accessed by a driver running within the operating system, and a firmware reserved memory, and the active node operating system memory further including an availability driver wherein the availability driver of the active node disables or suspends all processes that alter operating system memory and transfers all operation system memory of the active node to the operating system memory of the standby node, the isolated utility executive of the active node executes a code to generate an active validation array set of all operating system memory, the active validation array is then transferred to the standby node, the isolated utility executive of the standby node executes a code to generate a standby validation array set of all operating system memory that is verified against the active validation array; and the isolated utility executive of the standby node signals to the availability driver to complete or abort transfer of a network and storage device being used by the active node to the standby node.

In one embodiment, the isolated utility executive of the active node and of the standby node become completely idle after the availability driver is signaled. In one embodiment, the memory further includes stack memory, and wherein each stack memory page is validated using a data token.

### BRIEF DESCRIPTION OF THE DRAWINGS

The structure and function of the disclosure can be best understood from the description herein in conjunction with the accompanying figures. The figures are not necessarily to scale, emphasis instead generally being placed upon illustrative principles. The figures are to be considered illustrative in all aspects and are not intended to limit the invention, the scope of which is defined only by the claims.

FIG. 1 is a block diagram of a failover process in high reliability fault tolerant system in accordance with the disclosure.

FIG. 2 is a block diagram of the memory partitions of the computations nodes in accordance with the disclosure.

FIG. 3 is a block diagram of the actions performed on the memory partitions in accordance with the disclosure.

### DETAILED DESCRIPTION

High reliability fault tolerant computer systems require failover capabilities in response to process failures or other failure modes or signs of compute node failure. In part, the migration, failover or exchange process from a failing active node to a standby node may include a prediction of failure of the active node, an exchange of processor state and memory state information from an active node to a standby node. A Smart Exchange process further includes an entering of an active node, into a brownout phase and a blackout phase, wherein normal processor threads and memory write operations are partially and then completely suspended, and a transfer of a PCI device hierarchy from the active node to the standby node. A preparation for a blackout phase includes transmission of the full memory range of the active context to the standby context and an iterative transmission of all memory pages modified during any brownout phases. The present disclosure provides a method to detect any incorrectly copied or corrupted memory pages that may result from a misconfiguration on the standby node of a fault tolerant system that occur with a very short increase in processing time. In various embodiments, the method only increases the “blackout” processing time by factional seconds or seconds.

At a general level, for various system and method embodiments, memory pages on a primary or first (active) node are validated using some type of validation metric (hash, checksum, custom operator, etc.) to generate a first validation value. A secondary or second (standby) node receives memory pages and uses same validation metric to generate a second validation value which should match the first validation value before migration/smart exchange of state/memory data from primary node to secondary node. If validation values do not match, secondary memory hardware may need to be checked for errors/not used for migration. In some implementations, validation using a suitable validation metric may be performed while the end-user applications and OS are running and migration has started.

A customer's virtual machine guests might crash or experience corrupted data after a “smart exchange” that copies the entire processor/OS memory state onto the standby compute node, unless the software which performs this function can accurately identify all memory pages that must be copied. The systems and methods described herein and the use of a validation process to prevent or significantly reduce the probability of crashes or other data corruption that can undermine fault tolerant operation of entire PC server migrations.

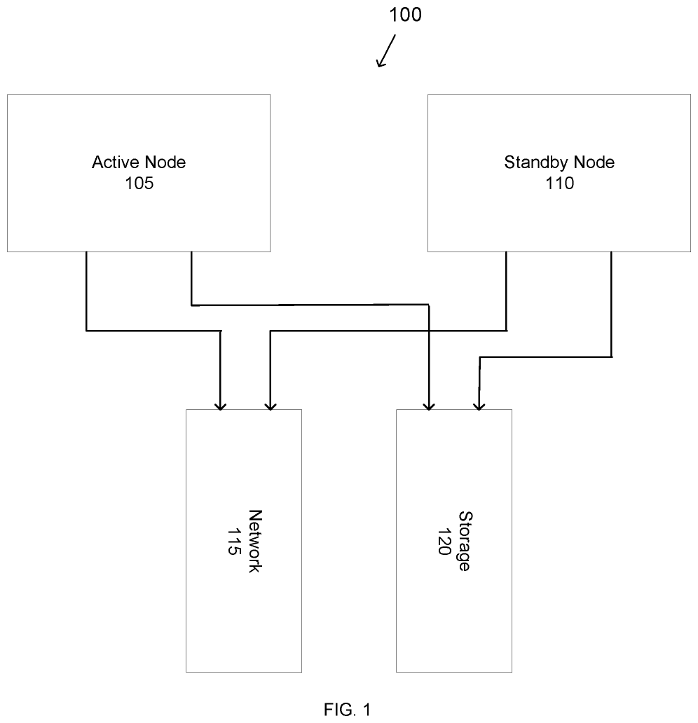

The exemplary embodiment of FIG. 1 displays in brief, a fault tolerant system 100 having failover capabilities. Failover is the ability for a system to recover to a standby node when the active node terminates or experiences a failure. The fault tolerant system may include but is not limited to an active node 105, a standby node 110, a network 115 and storage 120. In the event that the active node 105 begins to or actually fails, the system 100 can immediately recover by switching to the standby node 110 and the standby node 110 can continue to execute the processes of the active node 105. To ensure the system can recover, the active node 105 must transfer its complete operation state so the standby node 110 can execute the processes originally assigned to the active node 105. The transfer of the complete operation state can be described as a “smart exchange.” A smart exchange process can include various implantation specific details and may operate as a failover, a migration, a live migration, and may be used in a virtualized or non-virtualized fault tolerant system. In various embodiments, the OS memory is a portion of the system memory which the OS identified as belonging to the OS and the OS workload, as represented in some OS-generated files or data structures that can accesses by a driver running within the OS of the machine. The OS memory may include the designated memory pages in the BIOS or Unified Extensible Firmware Interface (UEFI) firmware table that is passed to the OS at system startup. In various embodiments, the standby node 110 will also connect to the storage 120, the network 115, and various peripheral devices. Memory verification between the active node 105 and standby node 110 is an advantageous design feature to complete the smart exchange, improve efficiency, and mitigate system downtime.

In various embodiments, a validation memory process is performed to ensure data integrity for smart exchange. Upon detecting a potential failure, the active node procedurally generates an array of each memory page of the operating state of the active node. In various embodiments, the arrays are generated by a checksum or hash function. The standby node is transferred a copy of the operating state of the active node. The standby node then runs an identical process to generate an array based on its copy of the operating state. The standby node then compares the arrays generated by the active node with the arrays generated by the standby node to verify the accuracy of the copy of the memory pages. Once this has complete, the standby node can resume the operations the active node suspended when it detected a potential failure.

In various embodiments, the present disclosure carries out memory validation of the operating state memory by use of a checksum or hash operation performed at high speeds. In many embodiments, standby node Bios and Boot firmware are identically or substantially identically configured to the Active node so that the memory layout, the firmware-reserved memory, and other configurable states are provisioned at boot time in a compatible manner among the two nodes. If a memory mismatch is detected, the smart exchange is aborted, and the user's workload continues to execute safely on the original compute node. Further, in some embodiments, volatile stack pages are validated using a specific data token in each stack page, rather than the same checksum or has which would not operate correctly on the volatile memory of the stack pages. In many embodiments, stack tokens maybe used to support or ensure memory integrity for the small number of stack pages such as 512 stack pages in active use on the system's operating system (OS) kernel mode environment at time of Smart Exchange

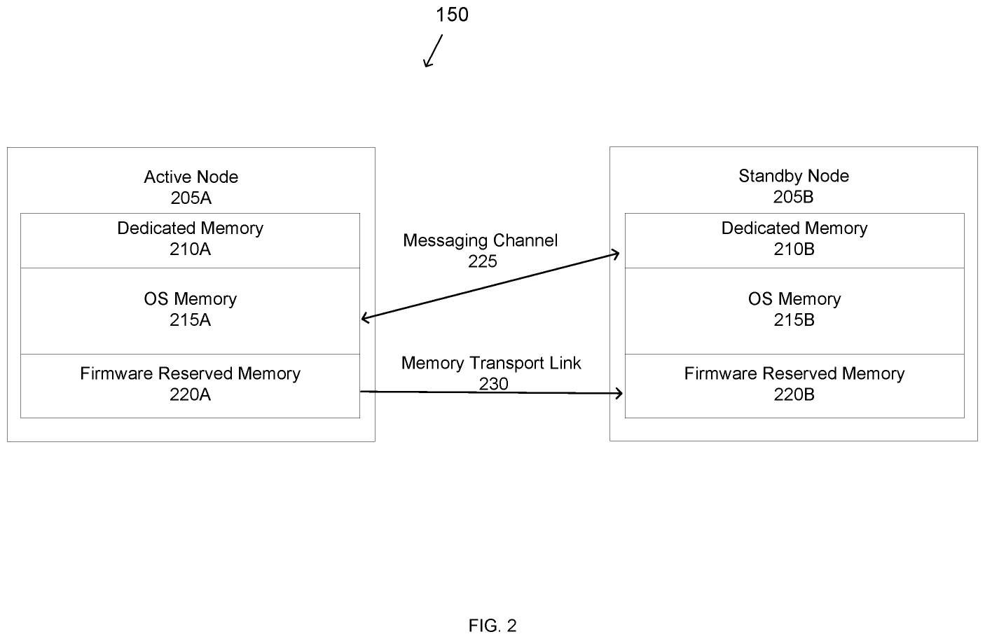

Refer now to the example embodiment of FIG. 2. FIG. 2 is a block diagram of a system 150 that include two compute nodes, an active node 205A and a standby node 205B. The compute nodes include memory which is partitioned into a dedicated memory 210A and 210B, an OS memory 215A, 215B, and a firmware reserved memory 220A and 220B. Data can be shared between the two nodes through a messaging channel 225 and a memory export channel 230.

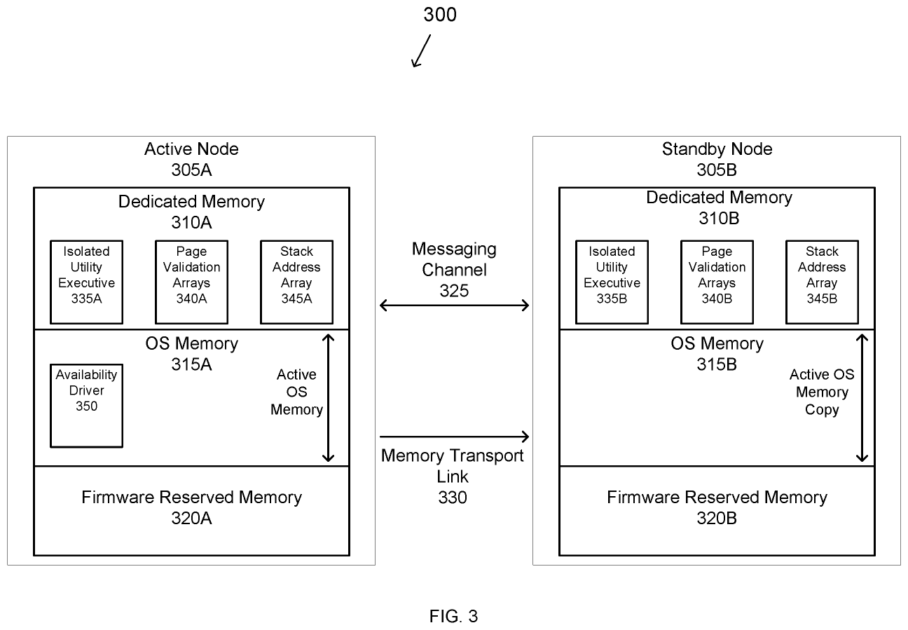

Refer now to the example embodiment of FIG. 3. FIG. 3 is a block diagram that depicts a system 300 that includes two compute nodes, an active node and a standby node. The two compute nodes include memory partitioned into a dedicated memory 310A and 310B, OS Memory 315A and 315B, and firmware reserved memory 320A and 320B. Data can be shared between the two nodes through a messaging channel 325 and a memory transport link 330.

Within the dedicated memory partitions 310A and 310B, both compute nodes have an isolated utility executive 335A and 335B, a region designated for the page validation array 340A and 340B, and a stack address array 345A and 345B. Additionally, within the OS memory 315A of the active node, there is an availability driver 350. The availability driver 350 is a kernel mode driver in some embodiments. Based on the operating system, the availability driver 350 may exist on both the active node 305A or the standby node 305B in slightly different compiled forms. In some embodiments, the availability driver may also be referred to as a platform driver. The availability driver may be a kernel mode driver in the operating system.

In various embodiments, the availability driver 350 and the isolated utility executive 335B of the standby node 305B perform a number of actions to verify the operation state. When a smart exchange to a standby node is initiated, the OS Memory 315A is copied sequentially onto the standby node 305B and kept current onto the standby node 305B with live DMA updates from the isolated utility executive 335B. The isolated utility executive 335B may also generate a digest of the PCIe device layout to configure the bus and endpoint space enumeration. Additionally, the isolated utility executive 335B may copy processor state memory such as model-specific registers and Local Apic (Local Advanced Programmable Interrupt Controller) states onto the standby node 305B. The Local Apic operates to handle the priority of interrupts. The Local APIC controller is typically built into every processor core, so it is per-processor resource.

In some embodiments, the processor stack pages are copied to the standby node at the same time that the Local Apic State and processor Register state is copied. The stack pages are validated by the presence of a data token in most embodiments. In one embodiment, there is no checksum validation performed for the stack pages, and only the data token is verified.

Then, the availability driver 350 enters a software critical section on all processors that execute the operating system with interrupts disabled and all I/O DMA quiesced. In various embodiments the stack pages may then be copied to the standby node 305B. In some embodiments, the stack pages may be copied explicitly at the same step which stores the Local Apic State. In many embodiments, the stack pages may be copied the same other pages in system memory, without any special action for those pages.

Next, the availability driver 350 calculates the validation array which is populated in the page validation arrays 340A of the active node's dedicated memory 310A. The validation array is calculated based on the OS memory. In various embodiments, the validation array is generated by a checksum or hash function. A value is created for each OS memory page. Next, it stores each processing stack address in the stack address array 345A. The stack pages may each contain a specific data token to enable their validation independent of the page validation arrays.

Next, the availability driver 350 copies the backing memory of the active node 305A to the standby node 305B. The backing memory will include the page validation arrays 340A and the stack address array 345A. The backing memory of the active node will occupy the regions designated for the page validation array(s) 340B and the stack address array(s) 345B. The backing memory will be copied using the memory transport link 330. The availability driver 350 will signal the standby node 305B to validate its memory using messaging channel 325.

After the availability driver 350 signals to the standby node 305B, the isolated utility executive 335B of the standby node 305B initiates a series of actions. First, it executes a software code to generate a new page validation array on all pages of active OS memory copy. The code must be performed with the same checksum or hash function utilized by the availability driver 350 to generate the first page validation array. Once completed, it compares the new page validation array with the first page validation array 340B to detect any errors. Additionally, a code will be executed on all processors to read the stack address array 345B and verify the required token values in each stack to detect any errors in the stack address array transfer. If no errors are detected in either the page validation array or the stack address array, the isolated utility executive will signal to the availability driver 350 to complete the smart exchange. In various embodiments, the smart exchange is completed when the network and storage device being used by the active node is transferred to the standby node. If errors are detected in either the page validation array or the stack address array, the isolated utility executive 335B will signal to the availability drive 350 to abort the smart exchange. If the smart exchange is to be completed, the disk and network can be transferred from the active node 305A to the standby node 305B. The standby node 305B may then resume the suspended processes of the active node 305A.

In various embodiments, after a smart exchange has been completed, the isolated utility executive 335B becomes completely idle, executes no further functions, and is unloaded. The backing memory of the isolated utility executive 335B may be over-written by a kernel driver with all-zero data. In various embodiments the production OS once again has exclusive functional control over the machine at the OS level aside from motherboard firmware.

In various embodiments, the software executed on the standby node has implementations that identify the sources of non-matching or failed memory pages. The system may be able to detect whether a memory defect is located within the backing memory, or if it occurs within the active OS memory copy. The software may also detect details of the memory that fails validation in order to characterize the failure mode that may have occurred.

In various embodiments, the validation array generation procedure runs in parallel on all processors to us the full system memory read bandwidth. In various embodiments, the isolated utility executive is a Virtual Machine Monitor (VMM) which executes in a reserved, non-OS region of memory to perform the validation array generation procured on the Standby node. In various embodiments, the system uses a validation array generation procedure that is built into the high-speed DMA capable fabric that connects the compute nodes such that the resulting validation data is deposited into a designated data store or array on the standby node. In various embodiments, the disclosed procedure can be optionally selected to occur on a system. In various embodiments, the described procedure is performed on an abbreviated cache line of the memory page. In various embodiments, while the validation array generation procedure may be a checksum or hash function, a person of ordinary skill would anticipate alternative validation array generation procedures.

Unless specifically stated otherwise as apparent from the following discussion, it is appreciated that throughout the description, discussions utilizing terms such as “processing” or “computing” or “calculating” or “delaying” or “comparing”, “generating” or “determining” or “forwarding” or “deferring” “committing” or “interrupting” or “handling” or “receiving” or “buffering” or “allocating” or “displaying” or “flagging” or Boolean logic or other set related operations or the like, refer to the action and processes of a computer system, or electronic device, that manipulates and transforms data represented as physical (electronic) quantities within the computer system's or electronic devices' registers and memories into other data similarly represented as physical quantities within electronic memories or registers or other such information storage, transmission or display devices.

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems is apparent from the description above. In addition, the present disclosure is not described with reference to any particular programming language, and various embodiments may thus be implemented using a variety of programming languages.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The examples presented herein are intended to illustrate potential and specific implementations of the present disclosure. The examples are intended primarily for purposes of illustration of the disclosure for those skilled in the art. No particular aspect or aspects of the examples are necessarily intended to limit the scope of the present disclosure.

The figures and descriptions of the present disclosure have been simplified to illustrate elements that are relevant for a clear understanding of the present disclosure, while eliminating, for purposes of clarity, other elements. Those of ordinary skill in the art may recognize, however, that these sorts of focused discussions would not facilitate a better understanding of the present disclosure, and therefore, a more detailed description of such elements is not provided herein.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “loader,” “filter,” “platform,” or “component” may include various computers or computer systems, or may include a reasonable combination of software, firmware, and/or hardware.

In various embodiments, of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure. Any of the servers, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it may be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present disclosure. Programming languages for computer software and other computer-implemented instructions may be translated into machine language by a compiler or an assembler before execution and/or may be translated directly at run time by an interpreter.

Examples of assembly languages include ARM, MIPS, and x86; examples of high level languages include Ada, BASIC, C, C++, C #, COBOL, Fortran, Java, Lisp, Pascal, Object Pascal; and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods, systems, and tools described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity.

Unless otherwise indicated, all numbers expressing lengths, widths, depths, or other dimensions and so forth used in the specification and claims are to be understood in all instances as indicating both the exact values as shown and as being modified by the term “about.” As used herein, the term “about” refers to a±10% variation from the nominal value. Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Any specific value may vary by 20%.

The invention may be embodied in other specific forms without departing from the spirit or essential characteristics thereof. The foregoing embodiments are therefore to be considered in all respects illustrative rather than limiting on the disclosure described herein. Scope of the invention is thus indicated by the appended claims rather than by the foregoing description, and all changes which come within the meaning and range of equivalency of the claims are intended to be embraced therein.

It will be appreciated by those skilled in the art that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. A computer comprising:
a network device;
a storage device; and
at least two compute nodes, wherein one compute node is designated an active node and the other compute node is designated a standby node, each compute node comprising
a dedicated memory with an isolated utility executive, an operating system memory, and a firmware reserved memory and the active node operating system memory further comprises an availability driver;
wherein the availability driver of the active node disables or suspends all processes that alter operating system memory and transfers all operation system memory of the active node to the operating system memory of the standby node;
the isolated utility executive of the active node executes a code to generate an active validation array set of all operating system memory, the active validation array is then transferred to the standby node.

2. The computer system of claim 1, wherein the isolated utility executive of the standby node executes a code to generate a standby validation array set of all operating system memory that is verified against the active validation array.

3. The computer system of claim 2, wherein the isolated utility executive of the standby node signals to the availability driver to complete or abort transfer of a network and storage device being used by the active node to the standby node.

4. The computer system of claim 1, wherein the compute nodes further comprise stack memory in the dedicated memory, wherein the stack memory can be verified through a data token.

5. The computer system of claim 1, wherein the active validation array and standby validation array are generated by a checksum or hash function.

6. The computer system of claim 1, wherein the isolated utility executive is a virtual machine monitor which executes in the dedicated memory to perform the validation array generation procured on the Standby node.

7. The computer system of claim 1, wherein the isolated utility executive of the active node and of the standby node execute code on all processers of the computer system in parallel to generate the active validation array and the standby validation array.

8. A method for verifying memory transfer in a fault tolerant computer system comprising:
providing a first compute node and a second compute node, the compute nodes having memory;
suspending system execution on the first compute node to prevent changes in memory on the first compute node;
generating a first array for every page of memory on the first compute node wherein the full memory bandwidth operates in parallel;
generating a second array for every page of memory on the second compute node wherein the full memory bandwidth operates in parallel;
verifying consistency between the first arrays on the first compute node and the second arrays on the second compute node;
transferring disk and network access to the second compute node; and
resuming system execution on the second compute node.

9. The method of claim 8, wherein the arrays on the first compute node and the arrays on the second compute node are generated by a checksum or hash function.

10. The method of claim 8 further comprising detecting an immediate or impending failure of the first compute node.

11. The method of claim 8, wherein the memory further includes stack memory, and wherein each stack memory page is validated using a data token.

12. The method of claim 8 further comprising transferring the memory of the first compute node to a second compute node via a virtual machine monitor.

13. A computer system configured to migrate a PC Server, the computer system comprising:
a network device;
a storage device; and
at least two compute nodes, wherein one compute node is designated an active node and the other compute node is designated a standby node, each compute node comprising
a dedicated memory with an isolated utility executive,
an operating system memory, the operating system memory including a plurality of files or data structures that are accessed by a driver running within the operating system, and a firmware reserved memory; and
the active node operating system memory further comprises an availability driver
wherein the availability driver of the active node disables or suspends all processes that alter operating system memory and transfers all operation system memory of the active node to the operating system memory of the standby node;
the isolated utility executive of the active node executes a code to generate an active validation array set of all operating system memory, the active validation array is then transferred to the standby node;
the isolated utility executive of the standby node executes a code to generate a standby validation array set of all operating system memory that is verified against the active validation array; and
the isolated utility executive of the standby node signals to the availability driver to complete or abort transfer of a network and storage device being used by the active node to the standby node.

14. The computer system of claim 13, wherein the isolated utility executive of the active node and of the standby node become completely idle after the availability driver is signaled.

15. The computer system of claim 13, wherein the memory further includes stack memory, and wherein each stack memory page is validated using a data token.
